(19) United States
(12) Patent Application Publication
(10) Pub. No.: US 2007/0067280 A1
(43) Pub. Date: Mar. 22, 2007

(54) System for recognising and classifying named entities

(75) Inventors: Guodong Zhou, Singapore (SG); Jian Su, Singapore (SG)

Correspondence Address: MORRISON & FOERSTER LLP, 425 MARKET STREET, SAN FRANCISCO, CA, 94105-2482, US

(73) Assignee: AGENCY FOR SCIENCE, TECHNOLOGY AND RESEARCH, Singapore (SG)

(21) Appl. No.: 10/585,235

(22) PCT Filed: Dec. 31, 2003
(86) PCT No.: PCT/SG03/00299

§ 371 Date: Jun. 29, 2006

(51) Int. Cl. G06F 17/30

(52) U.S. Cl. 707/5

(57) ABSTRACT

A Hidden Markov Model is used in Named Entity Recognition (NER). Using the constraint relaxation principle, a pattern induction algorithm is presented in the training process to induce effective patterns. The induced patterns are then used in the recognition process by a back-off modelling algorithm to resolve the data sparseness problem. Various features are structured hierarchically to facilitate the constraint relaxation process. In this way, the data sparseness problem in named entity recognition can be resolved effectively and a named entity recognition system with better performance and better portability can be achieved.

### FIELD OF THE INVENTION

The invention relates to Named Entity Recognition (NER), and in particular to automatic learning of patterns.

### BACKGROUND

Named Entity Recognition is used in natural language processing and information retrieval to recognise names (Named Entities (NEs)) within text and to classify the names within predefined categories, e.g. “person names”, “location names”, “organisation names”, “dates”, “times”, “percentages”, “money amounts”, etc. (usually also with a catch-all category “others” for words which do not fit into any of the more specific categories). Within computational linguistics, NER is part of information extraction, which extracts specific kinds of information from a document. With Named Entity Recognition, the specific information is entity names, which form a main component of the analysis of a document, for instance for database searching. As such, accurate naming is important.

Sentence elements can be partially viewed in terms of questions, such as the “who”, “where”, “how much”, “what” and “how” of a sentence. Named Entity Recognition performs surface parsing of text, delimiting sequences of tokens that answer some of these questions, for instance the “who”, “where” and “how much”. For this purpose a token may be a word, a sequence of words, an ideographic character or a sequence of ideographic characters. This use of Named Entity Recognition can be the first step in a chain of processes, with the next step relating two or more NEs, possibly even giving semantics to that relationship using a verb. Further processing is then able to discover the more difficult questions to answer, such as the “what” and “how” of a text.

It is fairly simple to build a Named Entity Recognition system with reasonable performance. However, there are still many inaccuracies and ambiguous cases (for instance, is “June” a person or a month? Is “pound” a unit of weight or currency? Is “Washington” a person's name, a US state or a town in the UK or a city in the USA?). The ultimate aim is to achieve human performance or better.

Previous approaches to Named Entity Recognition constructed finite state patterns manually. Using such systems attempts are made to match these patterns against a sequence of words, in much the same way as a general regular expression matcher. Such systems are mainly rule based and lack the ability to cope with the problems of robustness and portability. Each new source of text tends to require changes to the rules, to maintain performance, and thus such systems require significant maintenance. However, when the systems are maintained, they do work quite well.

More recent approaches tend to use machine-learning. Machine learning systems are trainable and adaptable. Within machine-learning, there have been many different approaches, for example: (i) maximum entropy; (ii) transformation-based learning rules; (iii) decision trees; and (iv) Hidden Markov Model.

Among these approaches, the evaluation performance of a Hidden Markov Model tends to be better than that of the others. The main reason for this is possibly the ability of a Hidden Markov Model to capture the locality of phenomena, which indicates names in text. Moreover, a Hidden Markov Model can take advantage of the efficiency of the Viterbi algorithm in decoding the NE-class state sequence.

Various Hidden Markov Model approaches are described in:

Bikel Daniel M., Schwartz R. and Weischedel Ralph M. 1999. An algorithm that learns what's in a name. Machine Learning (Special Issue on NLP);

Miller S., Crystal M., Fox H., Ramshaw L., Schwartz R., Stone R., Weischedel R. and the Annotation Group. 1998. BBN: Description of the SIFT system as used for MUC-7. MUC-7. Fairfax, Va.;

U.S. Pat. No. 6,052,682, issued on 18 Apr. 2000 to Miller S. et al. Method of and apparatus for recognizing and labeling instances of name classes in textual environments (which is related to the systems in both the Bikel and Miller documents above);

Yu Shihong, Bai Shuanhu and Wu Paul. 1998. Description of the Kent Ridge Digital Labs system used for MUC-7. MUC-7. Fairfax, Va.;

U.S. Pat. No. 6,311,152, issued on 30 Oct. 2001 to Bai Shuanhu. et al. System for Chinese tokenization and named entity recognition, which resolves named entity recognition as a part of word segmentation (and which is related to the system described in the Yu document above); and

Zhou GuoDong and Su Jian. 2002. Named Entity Recognition using an HMM-based Chunk Tagger. Proceedings of the 40th Annual Meeting of the Association for Computational Linguistics (ACL), Philadelphia, July 2002, pp. 473-480.

One approach within those using Hidden Markov Models relies on using two kinds of evidence to solve ambiguity, robustness and portability problems. The first kind of evidence is the internal evidence found within the word and/or word string itself. The second kind of evidence is the external evidence gathered from the context of the word and/or word string. This approach is described in “Zhou GuoDong and Su Jian. 2002. Named Entity Recognition using an HMM-based Chunk Tagger”, mentioned above.

### SUMMARY

According to one aspect of the invention, there is provided a method of back-off modelling for use in named entity recognition of a text, comprising, for an initial pattern entry from the text: relaxing one or more constraints of the initial pattern entry; determining if the pattern entry after constraint relaxation has a valid form; and moving iteratively up the semantic hierarchy of the constraint if the pattern entry after constraint relaxation is determined not to have a valid form.

According to another aspect of the invention, there is provided a method of inducing patterns in a pattern lexicon comprising a plurality of initial pattern entries with associated occurrence frequencies, the method comprising: identifying one or more initial pattern entries in the lexicon with lower occurrence frequencies; and relaxing one or more constraints of individual ones of the identified one or more initial pattern entries to broaden the coverage of the identified one or more initial pattern entries.

According to again another aspect of the invention, there is provided a system for recognising and classifying named entities within a text, comprising: feature extraction means for extracting various features from the document; recognition kernel means to recognise and classify named entities using a Hidden Markov Model; and back-off modelling means for back-off modelling by constraint relaxation to deal with data sparseness in a rich feature space.

According to a further aspect of the invention, there is provided a feature set for use in back-off modelling in a Hidden Markov Model, during named entity recognition, wherein the feature sets are arranged hierarchically to allow for data sparseness.

### INTRODUCTION TO THE DRAWINGS

The invention is further described by way of non-limitative example with reference to the accompanying drawings, in which:—

FIG. 1 is a schematic view of a named entity recognition system according to an embodiment of the invention;

FIG. 2 is a flow diagram relating to an exemplary operation of the Named Entity Recognition system of FIG. 1;

FIG. 3 is a flow diagram relating to the operation of a Hidden Markov Model of an embodiment of the invention;

FIG. 4 is a flow diagram relating to determining a lexical component of the Hidden Markov Model of an embodiment of the invention;

FIG. 5 is a flow diagram relating to relaxing constraints within the determination of the lexical component of the Hidden Markov Model of an embodiment of the invention; and

FIG. 6 is a flow diagram relating to inducing patterns in a pattern dictionary of an embodiment of the invention.

### DETAILED DESCRIPTION

According to a below-described embodiment, a Hidden Markov Model is used in Named Entity Recognition (NER). Using the constraint relaxation principle, a pattern induction algorithm is presented in the training process to induce effective patterns. The induced patterns are then used in the recognition process by a back-off modelling algorithm to resolve the data sparseness problem. Various features are structured hierarchically to facilitate the constraint relaxation process. In this way, the data sparseness problem in named entity recognition can be resolved effectively and a named entity recognition system with better performance and better portability can be achieved.

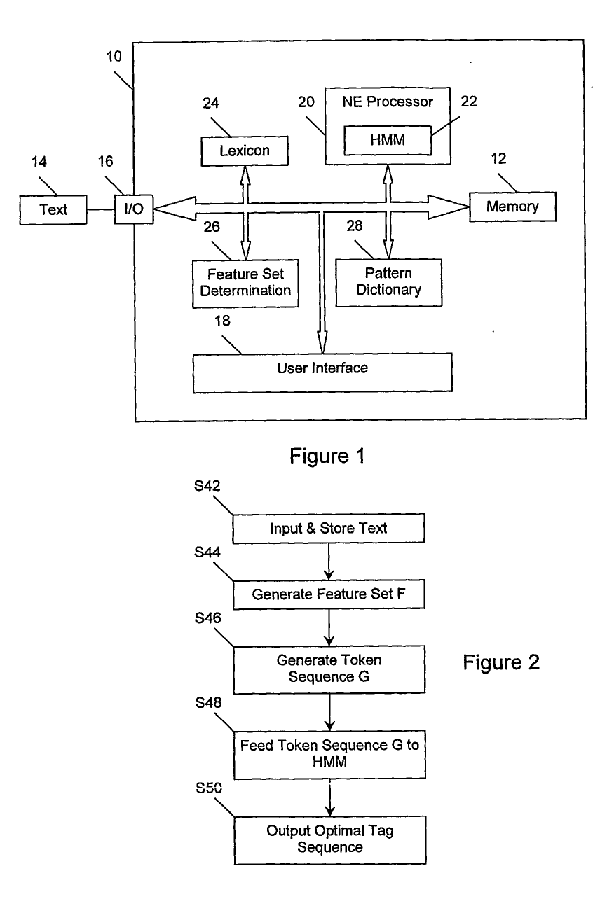

FIG. 1 is a schematic block diagram of a named entity recognition system 10 according to an embodiment of the invention. The named entity recognition system 10 includes a memory 12 for receiving and storing a text 14 input through an in/out port 16 from a scanner, the Internet or some other network or some other external means. The memory can also receive text directly from a user interface 18. The named entity recognition system 10 uses a named entity processor 20 including a Hidden Markov Model module 22, to recognise named entities in received text, with the help of entries in a lexicon 24, a feature set determination module 26 and a pattern dictionary 28, which are all interconnected in this embodiment in a bus manner.

In Named Entity Recognition a text to be analysed is input to a Named Entity (NE) processor 20 to be processed and labelled with tags according to relevant categories. The Named Entity processor 20 uses statistical information from a lexicon 24 and a ngram model to provide parameters to a Hidden Markov Model 22. The Named Entity processor 20 uses the Hidden Markov Model 22 to recognise and label instances of different categories within the text.

FIG. 2 is a flow diagram relating to an exemplary operation of the Named Entity Recognition system 10 of FIG. 1. A text comprising a word sequence is input and stored to memory (step S42). From the text a feature set F, of features for each word in the word sequence, is generated (step S44), which, in turn, is used to generate a token sequence G of words and their associated features (step S46). The token sequence G is fed to the Hidden Markov Model (step S48), which outputs a result in the form of an optimal tag sequence T (step S50), using the Viterbi algorithm.

A described embodiment of the invention uses HMM-based tagging to model a text chunking process, involving dividing sentences into non-overlapping segments, in this case noun phrases.

Determination of Features for Feature Set

The token sequence G (G₁ⁿ=g₁g₂. . . gₙ) is the observation sequence provided to the Hidden Markov Model, where, any token g, is denoted as an ordered pair of a word wᵢ itself and its related feature set fᵢ: gᵢ=<fᵢ,wᵢ>. The feature set is gathered from simple deterministic computation on the word and/or word string with appropriate consideration of context as looked up in the lexicon or added to the context.

The feature set of a word includes several features, which can be classified into internal features and external features. The internal features are found within the word and/or word string to capture internal evidence while external features are derived within the context to capture external evidence. Moreover, all the internal and external features, including the words themselves, are classified hierarchically to deal with any data sparseness problem and can be represented by any node (word/feature class) in the hierarchical structure. In this embodiment, two or three-level structures are applied. However, the hierarchical structure can be of any depth.

(A) Internal Features

The embodiment of this model captures three types of internal features:

i) f¹: simple deterministic internal feature of the words;

ii) f²: internal semantic feature of important triggers; and

iii) f³: internal gazetteer feature.

i) f¹ is the basic feature exploited in this model and organised into two levels: the small classes in the lower level are further clustered into the big classes (e.g. “Digitalisation” and “Capitalisation”) in the upper level, as shown in Table 1.

TABLE 1
Feature f¹: simple deterministic internal feature of words

| | Lower Level | | |
|---|---|---|---|
| Upper Level | Hierarchical feature f¹ | Example | Explanation |
| Digitalisation | ContainDigitAndAlpha | A8956-67 | Product Code |
| | YearFormat - | 90 | Two-Digit year |
| | TwoDigits | | |
| | YearFormat - | 1990 | Four-Digit year |
| | FourDigits | | |
| | YearDecade | 90s, 1990s | Year Decade |
| | DateFormat - | 09-99 | Date |
| | ContainDigitDash | | |
| | DateFormat - | 19/09/99 | Date |
| | ContainDigitSlash | | |
| | NumberFormat - | 19,000 | Money |
| | ContainDigitComma | | |
| | NumberFormat - | 1.00 | Money, |
| | ContainDigitPeriod | | Percentage |
| | NumberFormat - | 123 | Other Number |
| | ContainDigitOthers | | |
| Capitalisation | AllCaps | IBM | Organisation |
| | ContainCapPeriod - | M. | Person Name |
| | CapPeriod | | Initial |
| | ContainCapPeriod - | St. | Abbreviation |
| | CapPlusPeriod | | |
| | ContainCapPeriod - | N.Y. | Abbreviation |
| | CapPeriodPlus | | |
| | FirstWord | First word | No useful |
| | | of sentence | capitalisation |
| | | | information |
| | InitialCap | Microsoft | Capitalised Word |
| | LowerCase | will | Un-capitalised |
| | | | Word |
| Other | Other | $ | All other words |

The rationale behind this feature is that a) numeric symbols can be grouped into categories; and b) in Roman and certain other script languages capitalisation gives good evidence of named entities. As for ideographic languages, such as Chinese and Japanese, where capitalisation is not available, f¹ can be altered from Table 1 by discarding “FirstWord”, which is not available and combining “AllCaps”, “InitialCaps”, the various “ContainCapPeriod” sub-classes, “FirstWord” and “lowerCase” into a new class “Ideographic”, which includes all the normal ideographic characters/words while “Other” would include all the symbols and punctuation.

ii) f² is organised into two levels: the small classes in the lower level are further clustered into the big classes in the upper level, as shown in Table 2.

TABLE 2
Feature f²: the semantic classification of important triggers

| | Lower Level | | |
|---|---|---|---|
| Upper Level | Hierarchical | Example | |
| NE Type | feature f² | Trigger | Explanation |
| PERCENT | SuffixPERCENT | % | Percentage Suffix |
| MONEY | PrefixMONEY | $ | Money Prefix |
| | SuffixMONEY | Dollars | Money Suffix |
| DATE | SuffixDATE | Day | Date Suffix |
| | WeekDATE | Monday | Week Date |
| | MonthDATE | July | Month Date |
| | SeasonDATE | Summer | Season Date |
| | PeriodDATE - | Month | Period Date |
| | PeriodDATE1 | | |
| | PeriodDATE - | Quarter | Quarter/Half of Year |
| | PeriodDATE2 | | |
| | EndDATE | Weekend | Date End |
| TIME | SuffixTIME | a.m. | Time Suffix |
| | PeriodTime | Morning | Time Period |
| PERSON | PrefixPerson - | Mr. | Person Title |
| | PrefixPERSON1 | | |
| | PrefixPerson - | President | Person Designation |
| | PrefixPERSON2 | | |
| | NamePerson - | Michael | Person First Name |
| | FirstNamePERSON | | |
| | NamePerson - | Wong | Person Last Name |
| | LastNamePERSON | | |
| | OthersPERSON | Jr. | Person Name Initial |
| LOC | SuffixLOC | River | Location Suffix |
| ORG | SuffixORG - | Ltd | Company Name Suffix |
| | SuffixORGCom | | |
| | SuffixORG - | Univ. | Other Organisation |
| | SuffixORGOthers | | Name Suffix |
| NUMBER | Cardinal | Six | Cardinal Numbers |
| | Ordinal | Sixth | Ordinal Numbers |
| OTHER | Determiner, etc | the | Determiner |

f² in this underlying Hidden Markov Model is based on the rationale that important triggers are useful for named entity recognition and can be classified according to their semantics. This feature applies to both single word and multiple words. This set of triggers is collected semi-automatically from the named entities themselves and their local context within training data. This feature applies to both Roman and ideographic languages. The trigger effect is used as a feature in the feature set of g.

iii) f³ is organised into two levels. The lower level is determined by both the named entity type and the length of the named entity candidate while the upper level is determined by the named entity type only, as shown in Table 3.

TABLE 3
Feature f³: the internal gazetteer feature
(G: Global gazetteer, and n: the length of the matched named entity)

| Upper Level | Lower Level | |
|---|---|---|
| NE Type | Hierarchical feature f³ | Example |
| DATEG | DATEGn | Christmas Day: DATEG2 |
| PERSONG | PERSONGn | Bill Gates: PERSONG2 |
| LOCG | LOCGn | Beijing: LOCG1 |
| ORGG | ORGGn | United Nations: ORGG2 |

f³ is gathered from various look-up gazetteers: lists of names of persons, organisations, locations and other kinds of named entities. This feature determines whether and how a named entity candidate occurs in the gazetteers. This feature applies to both Roman and ideographic languages.

(B) External Features

The embodiment of this model captures one type of external feature:

iv) f⁴: external discourse feature.

iv) f⁴ is the only external evidence feature captured in this embodiment of the model. f⁴ determines whether and how a named entity candidate has occurred in a list of named entities already recognised from the document.

f⁴ is organised into three levels, as shown in Table 4:

1) The lower level is determined by named entity type, the length of named entity candidate, the length of the matched named entity in the recognised list and the match type.

2) The middle level is determined by named entity type and whether it is a full match or not.

3) The upper lever is determined by named entity type only.

TABLE 4
Feature f⁴: the external discourse
feature (those features not found in a Lexicon)
(L: Local document; n: the length of the matched named entity
in the recognised list; m: the length of named entity candidate;
Ident: Full Identity; and Acro: Acronym)

| Upper | Middle | Lower Level | | |
|---|---|---|---|---|
| Level | Level | Hierarchical | | |
| NE Type | Match Type | feature f⁴ | Example | Explanation |
| PERSON | PERL FullMatch | PERLIdentn | Bill Gates: | Full identity person |
| | | | PERLIdent2 | name |
| | | PERLAcron | G. D. ZHOU: | Person acronym for |
| | | | PERLAcro3 | “Guo Dong |
| | | | | ZHOU” |
| | PERL | PERLLastNamnm | Jordan: | Personal last name |
| | PartialMatch | | PERLLastNam21 | for “Michael |
| | | | | Jordan” |
| | | PERLFirstNamnm | Michael: | Personal first name |
| | | | PERLFirstNam21 | for “Michael |
| | | | | Jordan” |
| ORG | ORGLFullMatch | ORGLIdentn | Dell Corp.: | Full identity org |
| | | | ORGLIdent2 | name |
| | | ORGLAcron | NUS: | Org acronym for |
| | | | ORGLAcro3 | “National Univ. of |
| | | | | Singapore” |
| | ORGL | ORGLPartialnm | Harvard: | Partial match for |
| | PartialMatch | | ORGLtPartial21 | org “Harvard |
| | | | | Univ.” |
| LOC | LOCL | LOCLIdentn | New York: | Full identity |
| | FullMatch | | LOCLIdent2 | location name |
| | | LOCLAcron | N.Y: LOCLAcro2 | Location acronym |
| | | | | for “New York” |
| | LOCL | LOCLPartialnm | Washington: | Partial match for |
| | PartialMatch | | LOCLPartial31 | location |
| | | | | “Washington D.C.” |

f⁴ is unique to this underlying Hidden Markov Model. The rationale behind this feature is the phenomenon of name aliases, by which application-relevant entities are referred to in many ways throughout a given text. Because of this phenomenon, the success of named entity recognition task is conditional on the success in determining when one noun phrase refers to the same entity as another noun phrase. In this embodiment, name aliases are resolved in the following ascending order of complexity:
1) The simplest case is to recognise the full identity of a string. This case is possible for all types of named entities.
2) The next simplest case is to recognise the various forms of location names. Normally, various acronyms are applied, e.g. “NY” vs. “New York” and “N.Y.” vs. “New York”. Sometime, a partial mention is also used, e.g. “Washington” vs. “Washington D.C.”.
3) The third case is to recognise the various forms of personal proper names. Thus an article on Microsoft may include “Bill Gates”, “Bill” and “Mr. Gates”. Normally, the fill personal name is mentioned first in a document and later mention of the same person is replaced by various short forms such as an acronym, the last name and, to a lesser extent, the first name, or the full person name.
4) The most difficult case is to recognise the various forms of organisational names. For various forms of company names, consider a) “International Business Machines Corp.”, “International Business Machines” and “IBM”; b) “Atlantic Richfield Company” and “ARCO”. Normally, various abbreviated forms (e.g. contractions or acronyms) occur and/or the company suffix or suffices are dropped. For various forms of other organisation names, consider a) “National University of Singapore”, “National Univ. of Singapore” and “NUS”; b) “Ministry of Education” and “MOE”. Normally, acronyms and abbreviation of some long words occur.

During decoding, that is the processing procedure of the Named Entity processor, the named entities already recognised from the document are stored in a list. If the system encounters a named entity candidate (e.g. a word or sequence of words with an initial letter capitalised), the above name alias algorithm is invoked to determine dynamically if the named entity candidate might be an alias for a previously recognised name in the recognised list and the relationship between them. This feature applies to both Roman and ideographic languages.

For example, if the decoding process encounters the word “UN”, the word “UN” is proposed as an entity name candidate and the name alias algorithm is invoked to check if the word “UN” is an alias of a recognised entity name by taking the initial letters of a recognised entity name. If “United Nations” is an organisation entity name recognised earlier in the document, the word “UN” is determined as an alias of “United Nations” with the external macro context feature ORG2L2.

The Hidden Markov Model HMM

The input to the Hidden Markov Model includes one sequence: the observation token sequence G. The goal of the Hidden Markov Model is to decode a hidden tag sequence T given the observation sequence G. Thus, given a token sequence G₁ⁿ=g₁g₂. . . gₙ, the goal is, using chunk tagging, to find a stochastic optimal tag sequence T₁ⁿ=t₁t₂. . . tₙ that maximises

$$log P ( {T}_{1}^{n} \text{\textbar} {G}_{1}^{n} ) = log P ( {T}_{1}^{n} ) + log \frac{P ( {T}_{1}^{n} , {G}_{1}^{n} )}{P ( {T}_{1}^{n} ) \cdot P ( {G}_{1}^{n} )} , \qquad ( 1 )$$

The token sequence G₁ⁿ=g₁g₂. . . gₙ is the observation sequence provided to the Hidden Markov Model, where gᵢ=<fᵢ,wᵢ>, wᵢ is the initial i-th input word and fᵢ is a set of determined features related to the word wᵢ. Tags are used to bracket and differentiate various kinds of chunks.

The second term on the right-hand side of equation (1), log

$$\frac{P ( {T}_{1}^{n} , {G}_{1}^{n} )}{P ( {T}_{1}^{n} ) \cdot P ( {G}_{1}^{n} )} ,$$

is the mutual information between T₁ⁿ and G₁ⁿ. To simplify the computation of this item, mutual information independence (that an individual tag is only dependent on the token sequence G₁ⁿ and independent of other tags in the tag sequence T₁ⁿₙ) is assumed:

$$\begin{matrix}MI ( {T}_{1}^{n} , {G}_{1}^{n} ) = {\sum }_{i = 1}^{n} MI ( {t}_{i} , {G}_{1}^{n} ) , & ( 2 ) \\ i . e . log \frac{P ( {T}_{1}^{n} , {G}_{1}^{n} )}{P ( {T}_{1}^{n} ) \cdot P ( {G}_{1}^{n} )} = {\sum }_{i = 1}^{n} log \frac{P ( {t}_{i} , {G}_{1}^{n} )}{P ( {t}_{i} ) \cdot P ( {G}_{1}^{n} )} & ( 3 )\end{matrix}$$

Applying equation (3) to equation (1), provides:

$$\begin{matrix}log P ( {T}_{1}^{n} \text{\textbar} {G}_{1}^{n} ) = log P ( {T}_{1}^{n} ) + {\sum }_{l = 1}^{n} log \frac{P ( {t}_{l} , {G}_{1}^{n} )}{P ( {t}_{i} ) \cdot P ( {G}_{1}^{n} )} \\ & \\ log P ( {T}_{1}^{n} \text{\textbar} {G}_{1}^{n} ) = log P ( {T}_{1}^{n} ) - {\sum }_{l = 1}^{n} log P ( {t}_{i} ) + {\sum }_{l = 1}^{n} log P ( {t}_{i} \text{\textbar} {G}_{1}^{n} ) & ( 4 )\end{matrix}$$

Thus the aim is to maximise equation (4).

The basic premise of this model is to consider the raw text, encountered when decoding, as though the text had passed through a noisy channel, where the text had been originally marked with Named Entity tags. The aim of this generative model is to generate the original Named Entity tags directly from the output words of the noisy channel. This is the reverse of the generative model as used in some of the Hidden Markov Model related prior art. Traditional Hidden Markov Models assume conditional probability independence. However, the assumption of equation (2) is looser than this traditional assumption. This allows the model used here to apply more context information to determine the tag of a current token.

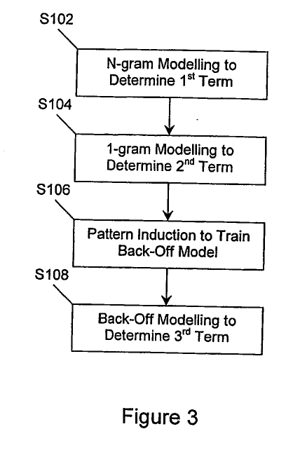

FIG. 3 is a flow diagram relating to the operation of a Hidden Markov Model of an embodiment of the invention. In step S102, ngram modelling is used to compute the first term on the right-hand side of equation (4). In step S104, ngram modelling, where n =1, is used to compute the second term on the right-hand side of equation (4). In step S106, pattern induction is used to train a model for use in determining the third term on the right-hand side of equation (4). In step S108, back-off modelling is used to compute the third term on the right-hand side of equation (4).

Within equation (4), the first term on the right-hand side, log P(T₁ⁿ), can be computed by applying chain rules. In n-gram modelling, each tag is assumed to be probabilistically dependent on the N−1 previous tags.

Within equation (4), the second term on the right-hand side,

$${\sum }_{i = 1}^{n} log P ( {t}_{i} ) ,$$

is the summation of log probabilities of all the individual tags. This term can be determined using a uni-gram model.

Within equation (4), the third term on the right-hand side,

$${\sum }_{i = 1}^{n} log P ( {t}_{i} \text{\textbar} {G}_{1}^{n} ) ,$$

corresponds to the “lexical” component (dictionary) of the tagger.

Given the above Hidden Markov Model, for NE-chunk tagging, token gᵢ=<fᵢwᵢ>,

where W₁ⁿ=w₁w₂. . . wₙ is the word sequence, F₁ⁿ=f₁f₂. . . fₙ is the feature set sequence and fᵢ is a set of features related with the word wᵢ.

Further, the NE-chunk tag, tᵢ, is structural and includes three parts:
1) Boundary category: B={0, 1, 2, 3}. Here 0 means that the current word, wᵢ, is a whole entity and 1/2/3 means that the current word, wᵢ, is at the beginning/in the middle/at the end of an entity name, respectively.
2) Entity category: E. E is used to denote the class of the entity name.
3) Feature set: F. Because of the limited number of boundary and entity categories, the feature set is added into the structural named entity chunk tag to represent more accurate models.

For example, in an initial input text “ . . . Institute for Infocomm Research . . . ”, there exists a hidden tag sequence (to be decoded by the Named Entity processor) “ . . . 1_ORG_{—}* 2_ORG_{—}* 3_*(where * represents the feature set F). Here, “Institute for Infocomm Research” is the entity name (as can be constructed from the hidden tag sequence), “Institute”/“for”/“Infocomm”/“Research” are at the beginning/in the middle/in the middle/at the end of the entity name, respectively, with the entity category of ORG.

There are constraints between sequential tags tᵢ₋₁ and tᵢ within the Boundary Category, BC, and the Entity Category, EC. These constraints are shown in Table 5, where “Valid” means the tag sequence tᵢ₋₁ tᵢ is valid, “Invalid” means the tag sequence tᵢ₋₁ tᵢ is invalid, and “Valid on” means the tag sequence tᵢ₋₁ tᵢ is valid as long as ECᵢ₋₁=ECᵢ (that is the EC for tᵢ₋₁ is the same as the EC for tᵢ).

TABLE 5
Constraints between tₗ₋₁ and tₗ

BC in tᵢ

| BC in tᵢ₋₁ | 0 | 1 | 2 | 3 |
|---|---|---|---|---|
| 0 | Valid | Valid | Invalid | Invalid |
| 1 | Invalid | Invalid | Valid on | Valid on |
| 2 | Invalid | Invalid | Valid on | Valid on |
| 3 | Valid | Valid | Invalid | Invalid |

Back-Off Modelling

Given the model and the rich feature set above, one problem is how to compute

$${\sum }_{i = 1}^{n} P ( {t}_{i} / {G}_{1}^{n} ) ,$$

the third term on the right-hand side of equation (4) mentioned earlier, when there is insufficient information. Ideally, there would be sufficient training data for every event whose conditional probability it is wished to calculate. Unfortunately, there is rarely enough training data to compute accurate probabilities when decoding new data, especially considering the complex feature set described above. Back-off modelling is therefore used in such circumstances as a recognition procedure.

The probability of tag tᵢ, given G₁ⁿ is P(tᵢ/G₁ⁿ). For efficiency, it is assumed that P(tᵢ/G₁ⁿ)≈P(t_{i|E}ᵢ), where the pattern entry Eᵢ=gᵢ₋₂gᵢ₋₁gᵢgᵢ₊₁gᵢ₊₂ and P(tᵢ|Eᵢ) as the probability of tag tᵢ related with Eᵢ. The pattern entry Eᵢ is thus a limited length token string, of five consecutive tokens in this embodiment. As each token is only a single word, this assumption only considers the context in a limited sized window, in this case of 5 words. As is indicated above, gᵢ=<fᵢ, wᵢ>, where wᵢ, is the current word itself and fᵢ<fᵢ¹, fᵢ², fᵢ², fᵢ³, fᵢ⁴> is the set of the internal and external features, in this embodiment four of the features, described above. For convenience, P(•|Eᵢ) is denoted as the probability distribution of various NE-chunk tags related with the pattern entry Eᵢ.

Computing P(•/Eᵢ) becomes a problem of finding an optimal frequently occurring pattern entry Eᵢ⁰, which can be used to replace P(•Eᵢ) with P(•|Eᵢ⁰) reliably. For this purpose, this embodiment uses a back-off modelling approach by constraint relaxation. Here, the constraints include all the f¹, f², f³, f⁴ and w (the subscripts are omitted) in Eᵢ. Faced with the large number of ways in which the constraints could be relaxed, the challenge is how to avoid intractability and keep efficiency. Three restrictions are applied in this embodiment to keep the relaxation process tractable and manageable:
(1) Constraint relaxation is done through iteratively moving up the semantic hierarchy of the constraint. A constraint is dropped entirely from the pattern entry if the root of the semantic hierarchy is reached.
(2) The pattern entry after relaxation should have a valid form, defined as ValidEntryForm={fᵢ₋₂fᵢ₋₁fᵢwᵢ, fᵢ₋₁fᵢwᵢfᵢ₊₁, fᵢ₋₁wᵢfᵢ₊₁fᵢ₊₂, fᵢ₋₁fᵢwᵢ, fᵢwᵢfᵢ₊₁, fᵢ₋₁wᵢ₋₁fᵢ, fᵢfᵢ₊₁wᵢ₊₁, fᵢ₋₂fᵢ₋₁fᵢ, fᵢ₋₁fᵢfᵢ₊₁, fᵢfᵢ₊₁fᵢ₊₂, fᵢwᵢ, fᵢ₋₁ fᵢ, fᵢfᵢ₊₁, fᵢ}.
(3) Each fₖ in the pattern entry after relaxation should have a valid form, defined as ValidFeatureForm ={<fₖ¹, fₖ², fₖ³, fₖ⁴>, <fₖ¹, Θ, fₖ³, Θ}>, <fₖ¹, Θ, Θ, fₖ⁴>, <fₖ¹, fₖ², Θ, Θ>, <fₖ¹, Θ, Θ>, <fₖ¹, Θ,Θ, Θ>}, where Θ means empty (dropped or not available).

The process embodied here solves the problem of computing P(tᵢ/G₁ⁿ) by iteratively relaxing a constraint in the initial pattern entry Eᵢ until a near optimal frequently occurring pattern entry Eᵢ⁰ is reached.

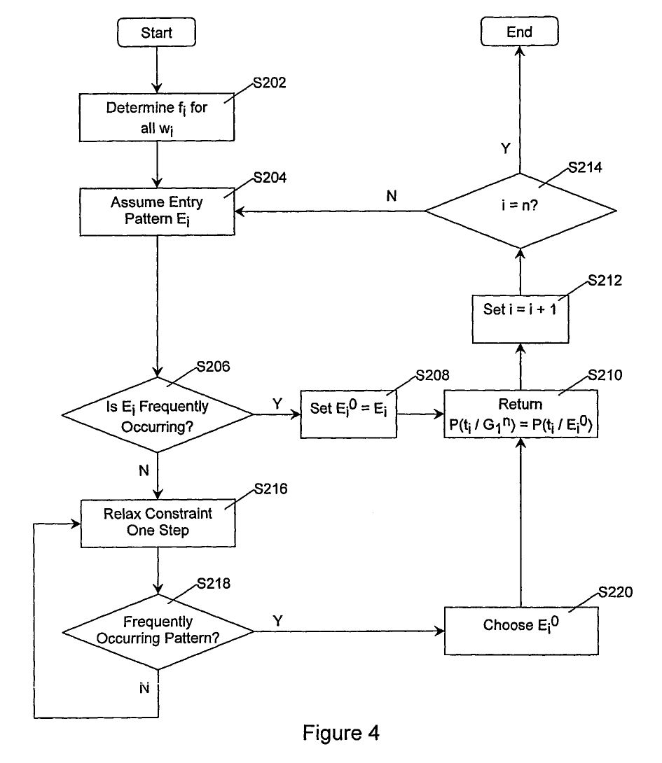

The process for computing P(tᵢ/G₁ⁿ) is discussed below with reference to the flowchart in FIG. 4. This process corresponds to step S108 of FIG. 3. The process of FIG. 4 starts, at step S202, with the feature set fᵢ=<fᵢ¹, fᵢ², fᵢ³, fᵢ⁴> being determined for all wᵢ within G₁ⁿ. Although this step in this embodiment occurs within the step for computing P(tᵢ/G₁ⁿ), that is step S108 of FIG. 3, the operation of step S202 can occur at an earlier point within the process of FIG. 3, or entirely separately.

At step S204, for the current word, wᵢ, being processed to be recognised and named, there is assumed a pattern entry Eᵢ=gᵢ₋₂gᵢ₋₁gᵢgᵢ₊₁gᵢ₊₂, where gᵢ=<fᵢ, wᵢ> and fᵢ=<fᵢ¹, fᵢ², fᵢ³,fᵢ⁴>.

At step S206, the process determines if Eᵢ is a frequently occurring pattern entry. That is a determination is made as to whether Eᵢ has an occurrence frequency of at least N, for example N may equal 10, with reference to a FrequentEntryDictionary. If Eᵢ is a frequently occurring pattern entry (Y), at step S208 the process sets Eᵢ⁰=Eᵢ, and the algorithm returns P(tᵢ/G₁ⁿ)=P(tᵢ/Eᵢ⁰), at step S210. At step S212, “i” is increased by one and a determination is made at step S214, whether the end of the text has been reached, i.e. whether i=n. If the end of the text has been reached (Y), the algorithm ends. Otherwise the process returns to step S204 and assumes a new initial pattern entry, based on the change in “i” in step S212.

If, at step S206, Eᵢ is a not a frequently occurring pattern entry (N), at step S216 a valid set of pattern entries C¹(Eᵢ) can be generated by relaxing one of the constraints in the initial pattern entry Eᵢ. Step S218 determines if there are any frequently occurring pattern entries within the constraint relaxed set of pattern entries. If there is one such entry, then that entry is chosen as Eᵢ⁰ and if there is more than one frequently occurring pattern entry, the frequently occurring pattern entry which maximises the likelihood measure is chosen as Eᵢ⁰, in step S220. The process reverts to step S210, where the algorithm returns P(tᵢ/G₁ⁿ)=P(tᵢ/Eᵢ⁰).

If step S218 determines that there are no frequently occurring pattern entries in C¹(Eᵢ), the process reverts to step S216, where a further valid set of pattern entries C²(Eᵢ) can be generated by relaxing one of the constraints in each pattern entry of C¹(Eᵢ). The process continues until a frequently occurring pattern entry E₀ is found within a constraint relaxed set of pattern entries.

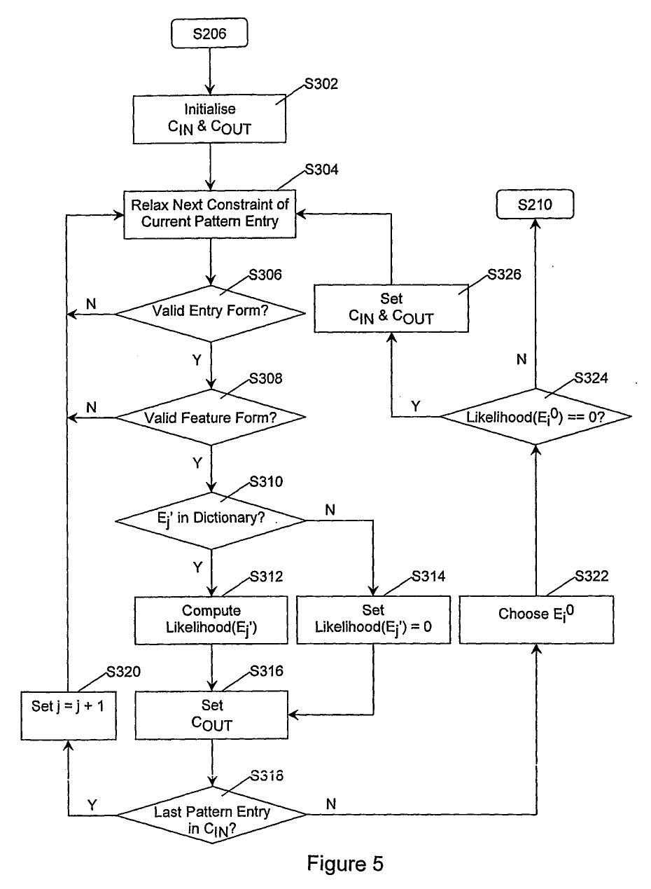

The constraint relaxation algorithm in computing P(tᵢ/G₁ⁿ), in particular that relating to steps S216, S218 and S220 in FIG. 4 above, is shown in more detail in FIG. 5.

The process of FIG. 5 starts as if, at step S206 of FIG. 4, Eᵢ is not a frequently occurring pattern entry. At step S302, the process initialises a pattern entry set before constraint relaxation C_{IN}={<Eᵢ, likelihood(Eᵢ)>} and a pattern entry set after constraint relaxation C_{OUT}={ } (here, likelihood(Eᵢ)=0).

At step S304, for a first pattern entry Eⱼ within C_{IN}, that is <Eⱼ, likelihood(Eⱼ)>εC_{IN}, a next constraint Cⱼ^{k} is relaxed (which in the first iteration of step S304 for any entry is the first constraint). The pattern entry Eⱼ after constraint relaxation becomes Eⱼ′. Initially, there is only one such entry Eⱼ in C_{IN}. However, that changes over further iterations.

At step S306, the process determines if Eⱼ′ is in a valid entry form in ValidEntryForm, where ValidEntryForm ={fᵢ₋₂fᵢ₋₁fᵢwᵢ, fᵢ₋₁fᵢwᵢfᵢ₊₁, fᵢwᵢfᵢ₊₁fᵢ₊₂, fᵢ₋₁fᵢwᵢ, fᵢwᵢfᵢ₊₁, fᵢ₋₁wᵢ₋₁fᵢ, fᵢfᵢ₊₁wᵢ₊₁, fᵢ₋₂fᵢ₋₁fᵢ, fᵢ₋₁fᵢfᵢ₊₁, fᵢfᵢ₊₁fᵢ₊₂, fᵢwᵢ, fᵢ₋₁fᵢ, fᵢfᵢ₊₁, fᵢ}. If Eⱼ′ is not in a valid entry form, the process reverts to step S304 and a next constraint is relaxed. If Eⱼ′ is in a valid entry form, the process continues to step S308.

At step S308, the process determines if each feature in Eⱼ′ is in a valid feature set fonts, where ValidFeatureForm ={<fₖ¹, fₖ², fₖ³, fₖ⁴ >, <fₖ¹, Θ, fₖ³, Θ}>, <fₖ¹, Θ, Θ, fₖ⁴>, <fₖ¹, fₖ², Θ, Θ, >, <fₖ¹, Θ, Θ, Θ>}. If Eⱼ′ is not in a feature set form, the process reverts to step S304 and a next constraint is relaxed. If Eⱼ′ is in a valid feature set form, the process continues to step S310.

At step S310, the process determines if Eⱼ′exists in a dictionary. If Eⱼ′ does exist in the dictionary (Y), at step S312 the likelihood of Eⱼ′ is computed as

$$likelihood ( {E}_{j}^{′} ) = \frac{number of {f}^{2} , {f}^{3} and {f}^{4} in {E}_{j}^{′} + 0.1}{number of {f}^{1} , {f}^{2} , {f}^{3} , {f}^{4} and w in {E}_{j}^{′}}$$

If Eⱼ′ does not exist in the dictionary (N), at step S314 the likelihood of Eⱼ′ is set as likelihood(Eⱼ′)=0.

Once the likelihood of Eⱼ′ has been set in step S312 or S314, the process continues with step S316, in which the pattern entry set after constraint relaxation C_{OUT} is altered, C_{OUT=C}_{OUT}+{<Eⱼ′,likelihood(Eⱼ′)>}.

Step S318 determines if the most recent Eⱼ is the last pattern entry Eⱼ within C_{IN}. If it is not, step S320 increases j by one, i.e. “j=j+1”, and the process reverts to step S304 for constraint relaxation of the next pattern entry Eⱼ within C_{IN}.

If Eⱼ is the last pattern entry Eⱼ within C_{IN} at step S318, this represents a valid set of pattern entries [C¹ (Eᵢ), C² (Eᵢ) or a further constraint relaxed set, mentioned above]. Eᵢ⁰ is chosen from the valid set of pattern entries at step S322 according to

$${E}_{i}^{0} = {arg max}_{< {E}_{j}^{′} , likelihood ( {E}_{j}^{′} ) > ∈ {C}_{OUT}} likelihood ( {E}_{j}^{′} )$$

A determination is made at step S324 as to whether the likelihood(Eᵢ⁰)=0. If the determination at step S324 is positive (i.e. that likelihood(E₁⁰)=0), at step S326 the pattern entry set before constraint relaxation and the pattern entry set after constraint relaxation are set, such that C_{IN=C}_{OUT} and C_{OUT}={ }. The process then reverts to step S304, where the algorithm starts going through the pattern entries Eⱼ′ as if they were Eⱼ, within reset C_{IN}, starting at the first pattern entry. If the determination at step S324 is negative, the algorithm exits the process of FIG. 5 and reverts to step S210 of FIG. 4, where the algorithm returns P(tᵢ/G₁ⁿ)=P(tᵢ/Eᵢ⁰).

The likelihood of a pattern entry is determined, in step S312, by the number of features f², f³ and f⁴ in the pattern entry. The rationale comes from the fact that the semantic feature of important triggers (f²), the internal gazetteer feature (f³) and the external discourse feature (f⁴) are more informative in determining named entities than the internal feature of digitalisation and capitalisation (f¹) and the words themselves (w). The number 0.1 added in the likelihood computation of a pattern entry, in step S312, to guarantee the likelihood is bigger than zero if the pattern entry is frequently occurred. This value can change.

An example is the sentence:
“Mrs. Washington said there were 20 students in her class”.

For simplicity in this example, the window size for the pattern entry is only three (instead of five, which is used above) and only the top three pattern entries are kept according to their likelihoods. Assume the current word is “Washington”, the initial pattern entry is E₂=g₁g₂g₃, where

g₁=<f₁¹=CapOtherPeriod, f₁²=PrefixPerson1, f₁³=Φ, f₁⁴=Φ, w₁=Mrs.>

g₂=<f₂¹=InitialCap, f₂²=Φ, f₂³=PER2L1, f₂⁴=LOC1G1, w₂=Washington>

g₃=<f₃^{I}=LowerCase, f₃²=Φf₃³=Φ, f₃⁴=Φ, w₃=said>

First, the algorithm looks up the entry E₂ in the FrequentEntryDictionary. If the entry is found, the entry E₂ is frequently occurring in the training corpus and the entry is returned as the optimal frequently occurring pattern entry. However, assuming the entry E₂ is not found in FrequentEntiyDictionary, the generalisation process begins by relaxing the constraints. This is done by dropping one constraint at every iteration. For the entry E₂, there are nine possible generalised entries since there are nine non-empty constraints. However, only six of them are valid according to ValidFeatureForm. Then the likelihoods of the six valid entries are computed and only the top three generalised entries are kept: E₂-w1 with a likelihood 0.34, E₂-w2 with a likelihood 0.34 and E₂-w3 with a likelihood 0.34. The three generalised entries are checked to determine whether they exist in the FrequentEntryDictionary. However, assuming none of them is found, the above generalisation process continues for each of the three generalised entries. After five generalisation processes, there is a generalised entry E₂-w₁-w₂-w₃-f₁³-f₂⁴ with the top likelihood 0.5. Assuming this entry is found in the FrequentEntryDictionary, the generalised entry E₂-w₁-w₂-w₃-j₁³-f₂⁴ is returned as the optimal frequently occurring pattern entry with the probability distribution of various NE-chunk tags.

Pattern Induction

The present embodiment induces a pattern dictionary of reasonable size, in which most if not every pattern entry frequently occurs, with related probability distributions of various NE-chunk tags, for use with the above back-off modelling approach. The entries in the dictionary are preferably general enough to cover previously unseen or less frequently seen instances, but at the same time constrained tightly enough to avoid over generalisation. This pattern induction is used to train the back-off model.

The initial pattern dictionary can be easily created from a training corpus. However, it is likely that most of the entries do not occur frequently and therefore cannot be used to estimate the probability distribution of various NE-chunk tags reliably. The embodiment gradually relaxes the constraints on these initial entries, to broaden their coverage, while merging similar entries to form a more compact pattern dictionary. The entries in the final pattern dictionary are generalised where possible within a given similarity threshold.

The system finds useful generalisation of the initial entries by locating and comparing entries that are similar. This is done by iteratively generalising the least frequently occurring entry in the pattern dictionary. Faced with the large number of ways in which the constraints could be relaxed, there are an exponential number of generalisations possible for a given entry. The challenge is how to produce a near optimal pattern dictionary while avoiding intractability and maintaining a rich expressiveness of its entries. The approach used is similar to that used in the back-off modelling. Three restrictions are applied in this embodiment to keep the generalisation process tractable and manageable:
(1) Generalisation is done through iteratively moving up the semantic hierarchy of a constraint. A constraint is dropped entirely from the entry when the root of the semantic hierarchy is reached.
(2) The entry after generalisation should have a valid form, defined as ValidEntryForm={fᵢ₋₂fᵢ₋₁fᵢwᵢ, fᵢ₋₁fᵢwᵢfᵢ₊₁, fᵢwᵢfᵢ₊₁fᵢ₊₂, fᵢ₋₁fᵢwᵢ, fᵢwᵢfᵢ₊₁, fᵢ₋₁wᵢ₋₁fᵢ, fᵢfᵢ₊₁wᵢ₊₁, fᵢ₋₂f₋₁fᵢ, fᵢ₌₁fᵢfᵢ₊₁, fᵢfᵢ₊₁fᵢ₊₂, fᵢwᵢ, fᵢ₋₁fᵢ, fᵢfᵢ₊₁, fᵢ}.
   (3) Each fₖ in the entry after generalisation should have a valid feature form, defined as ValidFeatureForm={<fₖ¹, fₖ², fₖ³,fₖ², fₖ⁴>, <fₖ¹, Θ, fₖ³, Θ}>, <fₖ¹, Θ, Θ, fₖ⁴>, <fₖ¹, fₖ², Θ, Θ,>, <fₖ¹, Θ, Θ, Θ,>}, where Θmeans such a feature is dropped or is not available.

The pattern induction algorithm reduces the apparently intractable problem of constraint relaxation to the easier problem of finding an optimal set of similar entries. The pattern induction algorithm automatically determines and exactly relaxes the constraint that allows the least frequently occurring entry to be unified with a set of similar entries. Relaxing the constraint to unify an entry with a set of similar entries has the effect of retaining the information shared with a set of entries and dropping the difference. The algorithm terminates when the frequency of every entry in the pattern dictionary is bigger than some threshold (e.g. 10).

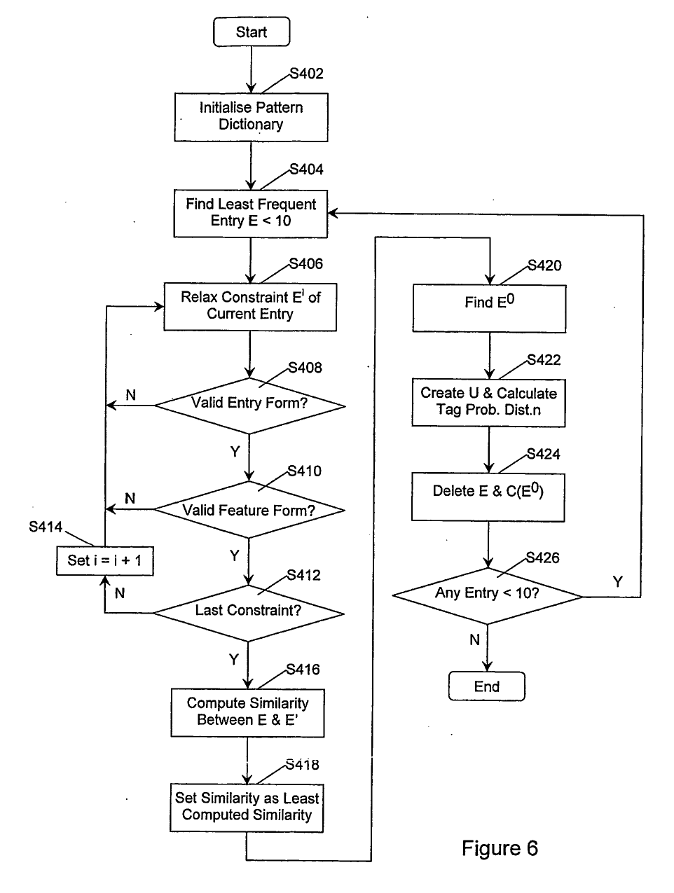

The process for pattern induction is discussed below with reference to the flowchart in FIG. 6.

The process of FIG. 6 starts, at step S402, with initialising the pattern dictionary. Although this step is shown as occurring immediately before pattern induction, it can be done separately and independently beforehand.

The least frequently occurring entry E in the dictionary, with a frequency below a predetermined level, e.g. <10, is found in step S404. The constraint Eⁱ (which in the first iteration of step S406 for any entry is the first constraint) in the current entry E is relaxed one step, at step S406, such that E′ becomes the proposed pattern entry. Step S408 determines if the proposed constraint relaxed pattern entry E′ is in a valid entry form in ValidEntryForm. If the proposed constraint relaxed pattern entry E′ is not in a valid entry form, the algorithm reverts to step S406, where the same constraint Eⁱ is relaxed one step further. If the proposed constraint relaxed pattern entry E′ is in a valid entry form, the algorithm proceeds to step S410. Step S410 determines if the relaxed constraint Eⁱ is in a valid feature form in ValidFeatureForm. If the relaxed constraint Eⁱ is not valid, the algorithm reverts to step S406, where the same constraint Eⁱ is relaxed one step further. If the relaxed constraint Eⁱ is valid, the algorithm proceeds to step S412.

Step S412 determines if the current constraint is the last one within the current entry E. If the current constraint is not the last one within the current entry E, the process passes to step S414, where the current level “i” is increased by one, i.e. “i=i+1”. After which the process reverts to step S406, where a new current constraint is relaxed a first level.

If the current constraint is determined as being the last one within the current entry E at step S412, there is now a complete set of relaxed entries C(Eⁱ), which can be unified with E by relaxation of Eⁱ. The process proceeds to step S416, where for every entry E′ in C(Eⁱ), the algorithm computes Similarity(E,E′ ), which is the similarity between E and E′ , using their NE-chunk tag probability distributions:

$$Similarity ( E , {E}^{′} ) = \sqrt{\frac{{\sum }_{i} P ( {t}_{i} \text{\textbar} E ) \cdot P ( {t}_{i} \text{\textbar} {E}^{′} )}{\sqrt{{\sum }_{i} {P}^{2} ( {t}_{i} \text{\textbar} E )} \cdot \sqrt{{\sum }_{i} {P}^{2} ( {t}_{i} \vert {E}^{′} )}}}$$

In step S418, the similarity between E and C(Eⁱ) is set, as the least similarity between E and any entry E′ in C(Eⁱ):

$$Similarity ( E , C ( {E}^{i} ) ) = {min}_{{E}^{i} ∈ C ( {E}^{i} )} Similarity ( E , {E}^{i} ) .$$

In step S420, the process also determines the constraint E⁰ in E, of any possible constraint Eⁱ, which maximises the similarity between E and C(Eⁱ):

$${E}^{0} = {arg max }_{{E}^{i}} Similarity ( E , C ( {E}^{i} ) ) .$$

In step S422, the process creates a new entry U in the dictionary, with the constraint E⁰ just relaxed, to unify the entry E and every entry in C(E⁰), and computes entry U's NE-chunk tag probability distribution. The entry E and every entry in C(E⁰) is deleted from the dictionary in step S424.

At step 426, the process determines if there is any entry in the dictionary with a frequency of less than the threshold, in this embodiment less than 10. If there is no such entry, the process ends. If there is an entry in the dictionary with a frequency of less than the threshold, the process reverts to step S404, where the generalisation process starts again for the next infrequent entry.

In contrast with existing systems, each of the internal and external features, including the internal semantic features of important triggers and the external discourse features and the words themselves, is structured hierarchically.

The described embodiment provides effective integration of various internal and external features in a machine learning-based system. The described embodiment also provides a pattern induction algorithm and an effective back-off modelling approach by constraint relaxation in dealing with the data sparseness problem in a rich feature space.

This embodiment presents a Hidden Markov Model, a machine learning approach, and proposes a named entity recognition system based on the Hidden Markov Model. through the Hidden Markov Model, with a pattern induction algorithm and an effective back-off modelling approach by constraint relaxation to deal with the data sparseness problem, the system is able to apply and integrate various types of internal and external evidence effectively. Besides the words themselves, four types of evidence are explored:

1) simple deterministic internal features of the words, such as capitalisation and digitalisation; 2) unique and effective internal semantic features of important trigger words; 3) internal gazetteer features, which determine whether and how the current word string appears in the provided gazetteer list; and 4) unique and effective external discourse features, which deal with the phenomenon of name aliases. Moreover, each of the internal and external features, including the words themselves, is organised hierarchically to deal with the data sparseness problem. In such a way, the named entity recognition problem is resolved effectively.

In the above description, various components of the system of FIG. 1 are described as modules. A module, and in particular its functionality, can be implemented in either hardware or software. In the software sense, a module is a process, program, or portion thereof, that usually performs a particular function or related functions. In the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

1. A method of back-off modelling for use in named entity recognition of a text, comprising, for an initial pattern entry from the text:
relaxing one or more constraints of the initial pattern entry;
determining if the pattern entry after constraint relaxation has a valid form; and
moving iteratively up the semantic hierarchy of the constraint if the pattern entry after constraint relaxation is determined not to have a valid form.

2. A method according to claim 1, wherein moving iteratively up the semantic hierarchy of the constraint if the pattern entry after constraint relaxation is determined not to have a valid form comprises:
moving up the semantic hierarchy of the constraint;
relaxing the constraint further; and
returning to determining if the pattern entry after constraint relaxation has a valid form.

3. A method according to claim 1, further comprising:
determining if a constraint in the pattern entry, after relaxation, also has a valid form; and
moving iteratively up the semantic hierarchy of the constraint if the constraint in the pattern entry after constraint relaxation is determined not to have a valid form.

4. A method according to claim 3, wherein moving iteratively up the semantic hierarchy of the constraint if the constraint in the pattern entry after constraint relaxation is determined not to have a valid form comprises:
moving up the semantic hierarchy of the constraint;
relaxing the constraint further; and
returning to determining if a constraint in the pattern entry after constraint relaxation has a valid form.

5. A method according to claim 1, wherein if a constraint is relaxed, the constraint is dropped entirely from the pattern entry if the relaxation reaches the root of the semantic hierarchy.

6. A method according to claim 1, further comprising terminating if a near optimal frequently occurring pattern entry is reached to replace the initial pattern entry.

7. A method according to claim 1, further comprising selecting the initial pattern entry for back-off modelling if it is not a frequently occurring pattern entry in a lexicon.

8. A method of inducing patterns in a pattern lexicon comprising a plurality of initial pattern entries with associated occurrence frequencies, the method comprising:
identifying one or more initial pattern entries in the lexicon with lower occurrence frequencies; and
relaxing one or more constraints of individual ones of the identified one or more initial pattern entries to broaden the coverage of the identified one or more initial pattern entries.

9. A method according to claim 8, further comprising creating the pattern lexicon of initial pattern entries from a training corpus.

10. A method according to claim 8, further comprising merging individual ones of the constraint relaxed initial pattern entries with similar pattern entries in the lexicon to form a more compact pattern lexicon.

11. A method according to claim, wherein the entries in the compact pattern lexicon are generalised as much as possible within a given similarity threshold.

12. A method according to claim 8, further comprising:
determining if the pattern entry after constraint relaxation has a valid form; and
moving iteratively up the semantic hierarchy of the constraint if the pattern entry after constraint relaxation is determined not to have a valid form.

13. A method according to claim 12, wherein moving iteratively up the semantic hierarchy of the constraint if the pattern entry after constraint relaxation is determined not to have a valid form comprises:
moving up the semantic hierarchy of the constraint;
relaxing the constraint further; and
returning to determining if the pattern entry after constraint relaxation has a valid form.

14. A method according to claim 12, further comprising:
determining if a constraint in the pattern entry, after relaxation, also has a valid form; and
moving iteratively up the semantic hierarchy of the constraint if the constraint in the pattern entry after constraint relaxation is determined not to have a valid form.

15. A method according to claim 14, wherein moving iteratively up the semantic hierarchy of the constraint if the constraint in the pattern entry after constraint relaxation is determined not to have a valid form comprises:
moving up the semantic hierarchy of the constraint;
relaxing the constraint further; and
returning to determining if a constraint in the pattern entry after constraint relaxation has a valid form.

16. A decoding process in a rich feature space comprising a method according to claim 1.

17. A training process in a rich feature space comprising a method according to claim 8.

18. A system for recognising and classifying named entities within a text, comprising:
feature extraction means for extracting various features from a document;
recognition kernel means to recognise and classify named entities using a Hidden Markov Model; and
back-off modelling means for back-off modelling by constraint relaxation to deal with data sparseness in a rich feature space.

19. A system according to claim 18, wherein the back-off modelling means is operable to provide a method of back-off modelling according to claim 1.

20. A system according to claim 18, further comprising a pattern induction means for inducing frequently occurring patterns.

21. A system according to claim 20, wherein the pattern induction means is operable to provide a method of inducing patterns according to claim 8.

22. A system according to claim 18, wherein said various features are extracted from words within the text and the discourse of the text, and comprise one or more of:
a) deterministic features of words, including capitalisation or digitalisation;
b) semantic features of trigger words;
c) gazetteer features, which determine whether and how the current word string appears in a gazetteer list;
d) discourse features, which deal with the phenomena of name alias; and
e) the words themselves.

23. A feature set for use in back-off modelling in a Hidden Markov Model, during named entity recognition, wherein the feature sets are arranged hierarchically to allow for data sparseness.
